(19) United States
(12) Patent Application Publication
(10) Pub. No.: US 2025/0376578 A1
(43) Pub. Date: Dec. 11, 2025

(54) PECTIN-CELLULOSE NANOFIBER COMPOSITE FOR MODIFIED ATMOSPHERE PACKAGING

(71) Applicant: Purdue Research Foundation, West Lafayette, IN (US)

(72) Inventors: Alexander Wei, West Lafayette, IN (US); Nosa Believe Idahagbon, Lafayette, IN (US)

(73) Assignee: Purdue Research Foundation, West Lafayette, IN (US)

(21) Appl. No.: 19/174,522

(22) Filed: Apr. 9, 2025

Related U.S. Application Data
(60) Provisional application No. 63/658,594, filed on Jun. 11, 2024.

(51) Int. Cl. C08L 1/02; C08J 5/18; C08K 3/26; C08K 3/38; C08K 7/02; C08L 5/06; C09D 7/40; C09D 7/61; C09D 7/65; C09D 105/06; D21H 19/34; D21H 27/10

(52) U.S. Cl. CPC C08L 1/02; C08J 5/18; C08K 3/26; C08L 5/06; C09D 7/61; C09D 7/65; C09D 7/70; C09D 105/06; D21H 19/34; D21H 27/10; C08J 2301/02; C08J 2305/06; C08K 2003/262; C08K 2003/387; C08K 7/02; C08L 2201/06; C08L 2201/14; C08L 2205/16

(57) ABSTRACT

A pectin-based composite barrier comprising (i) a pectin. (ii) a cellulose nanofiber (CNF), and (iii) a mild base such as sodium borate (NaB) or sodium carbonate (NaC) and a packaging product, such as a modified atmosphere packaging product, comprising same.

### CROSS-REFERENCE TO RELATED APPLICATION

This application claims priority to U.S. provisional patent application No. 63/658,594, which was filed Jun. 11, 2024, and which is hereby incorporated by reference in its entirety.

### STATEMENT OF GOVERNMENT SUPPORT

This invention was made with government support under CHE 2204206 awarded by the National Science Foundation. The government has certain rights in the invention.

### TECHNICAL FIELD

The present disclosure relates to food packaging material. In particular, the disclosure relates to a pectin-based composite, such as pectin-cellulose nanofiber (pectin-CNF) composite comprising a mild base such as sodium borate or sodium carbonate, and its use in modified atmosphere packaging.

### BACKGROUND

There is a global drive to reduce the environmental burden of single-use packaging by replacing petroleum-based plastics with biorenewable ones. This is particularly relevant in the food industry, where perishable foods are long outlived by packaging materials made from polyethylene (PE), polyethylene terephthalate (PET), polypropylene (PP), or polyvinyl chloride (PVC) (Guillard et al., Frontiers in Nutrition, 2018, vol. 5). However, packaging plays a vital role in protecting food against physical damage and spoilage by moisture or oxidation and in preserving its sensory properties (Vasile and Baican, Molecules, 2021, 26, Article 1263). Biorenewable plastics are appealing but face several limitations that impede their widespread adoption: for example, polylactic acid (PLA) has poor thermal stability and inadequate barrier properties (Singha and Hedenqvist, Polymers, 2020, 12, Article 1095), and polyhydroxyalkanoates (PHAs) are brittle and difficult to process or recycle (Naser et al., RSC Advances, 2021, 11, 17151-17196). There are also concerns that a large-scale transition to bioplastics might amplify the strain on natural resources and compete with food production (Brizga et al., One Earth, 2020, 3, 45-53). With such limitations, developing bioplastics from source materials that complement rather than compete with food production is imperative. In this regard, second-generation feedstocks from harvest or food waste products are especially valuable and are key factors in the development of sustainable packaging (Ncube et al., Materials, 2020, 13, Article 4994; Mendes and Petersen, Trends in Food Science and Technology, 2021, 112, 839-846).

Pectin is traditionally used as a gelling and thickening agent or as an emulsion stabilizer in food products, but more recently, it has been considered as a component of biodegradable or edible food packaging. However, pectin by itself is hygroscopic and has a low tensile strength (TS; 2-6 MPa) and Young's modulus (E_{Y}, 0.02-0.1 GPa) at relative humidities (RH) commonly associated with unprocessed foods. For this reason, efforts have been focused on developing pectin-based composites with greater mechanical strength at high RH (Isopencu et al., Materials, 2021, 13, Article 673). Pectin-based films can be strengthened by electrostatic bonding with metal ions or cationic polysaccharides such as chitosan (Lorevice et al., Food Hydrocolloids, 2016, 52, 732-740) and also by reinforcement with inorganic fillers (Nesic et al., Foods, 2022, 11, 360) or biorenewable fibers (Bernhardt et al., Carbohydrate Polymers, 2017, 164, 13-22; Mendes et al., Trends in Food Science and Technology, 2020, 112, 839-846).

Nanocellulosic fibers are ideal fillers for pectin-based films and packaging. Nanocellulose has a high Young's modulus (>100 GPa) and has been widely used to enhance the mechanical strength of both synthetic and biorenewable plastics. Nearly all reports on nanocellulose-reinforced pectin involve BC or CNCs, sometimes in combination with inorganic fillers or antimicrobial agents. Pectin reinforced with cellulose nanocrystal (CNC) shows improved barriers to water permeation (Isopencu et al., Carbohydrate Polymer Technologies and Applications, 2021, 2, Article 100057) but only a modest increase in tensile strength at low CNC loadings (Azeredo et al., Journal of Food Science, 2009, 74, N31-N35; Chaichi et al., 2017, Carbohydrate Polymers, 157, 167-175; Sharaby et al., Scientific Reports, 2022, 12, 20673), and a decline in mechanical properties at higher loadings (Abdollahi et al., International Journal of Biological Macromolecules, 2013, 54, 166-173).

In view of the above, it is an object to provide a pectin-based composite for food packaging, especially for modified atmosphere packaging (MAP), that provides better humidity regulation, improves moisture preservation, and reduces oxidative browning of fruits. This and other objects and advantages, as well as inventive features, will be apparent from the detailed description provided herein.

### SUMMARY

Provided is a pectin-based composite barrier comprising (i) a pectin, (ii) a cellulose nanofiber (CNF), and (iii) a mild base selected from sodium borate (NaB) and sodium carbonate (NaC).

The pectin-based composite barrier can comprise about 17 wt % to about 70 wt % of CNF. In some embodiments, the composite barrier can comprise about 30 wt % to about 70 wt % of CNF. The pectin-based composite barrier can comprise about 25 wt % to about 80 wt % of pectin. The amount of pectin and the amount of CNF that can be used in the composite barrier are in a weight ratio between about 80:20 and about 30:70. The composite barrier can comprise a mild base of about 0.1 wt % to about 15 wt %. In some embodiments, the mild base is NaB. In some embodiments, the mild base is NaC. In some embodiments, the pectin-cellulose nanofiber (CNF)-NaB composite barrier comprises about 43% of pectin, about 43% of CNF, and about 14% of NaB.

The pectin-based composite barrier can be a composite film or a composite coating. The pectin-based composite film can have a thickness from about 0.10 mm to about 1.0 mm. The pectin-based composite film can have a tensile strength of about 5.5 MPa to about 160 MPa, when measured at about 70% to about 80% relative humidity (RH).

Also provided is a packaging product comprising a pectin-based composite barrier as described above. In some embodiments, the packaging product is a modified atmosphere packaging product. The pectin-based composite barrier can control the RH in the packaging product from about 55% to about 70% while maintaining a water absorption of about 5 mg/cm². In some embodiments, the pectin-based composite barrier can maintain said RH values at a temperature of about 1° C. to about 3° C.

### BRIEF DESCRIPTION OF THE DRAWINGS

The present disclosure will be more readily understood from the detailed description of embodiments presented below, considered in conjunction with the attached drawings of which:

FIG. 1A shows a pectin-cellulose nanofiber (CNF)-sodium borate (NaB) composite film (8.5 cm×18.5 cm) (e.g., low methoxy density pectin-50 wt % CNF-NaB (L-₅₀CNF-B) as a representative sample) after drying. The resulting films had a mean thickness of 250 μm and were visibly smooth.

FIG. 1B shows a plan view of a scanning electron microscope (SEM) image of conditioned pectin-CNF-NaB composite film (5000× magnification).

FIG. 1C shows an edge view of an SEM image of fractured pectin-CNF-NaB composite film (e.g., L-50CNF-B).

FIG. 1D shows an edge view of an SEM image of fractured pectin-CNF-NaB composite film (e.g., L-50CNF-B).

FIG. 1E shows a test coupon (1.9 cm×16.5 cm) cut from the conditioned pectin-CNF-NaB composite film (e.g., L-50CNF-B), folded in half. Free-standing pectin-CNF-NaB films become ductile after conditioning at 80-90% relative humidity (RH) at ambient temperature and could be cut into coupons and folded onto themselves without fracturing.

FIG. 2A shows water absorption (WA) normalized values (±σ) of pectin-CNF composite films incubated in 80% RH at 25° C. (N=3).

FIG. 2B shows water vapor permeability (WVP) values of pectin-CNF-NaB composite films measured at 50% RH.

FIG. 3A shows anisidine values of corn oil preserved in bottles sealed with pectin-CNF composite films with or without 14 wt % NaB plus controls (capped and uncapped vials) for 7 days at 85° C.

FIG. 3B shows anisidine values of corn oil preserved in bottles sealed with L-50CNF or high methoxy density pectin (H)-50CNF composite film prepared with 14 wt % NaB or NaC for 7 days at 85° C.

FIG. 3C shows anisidine values of corn oil preserved in bottles sealed with L-50CNF or H-50CNF composite film prepared with variable wt % of NaB for 7 days at 85° C.

FIG. 3D shows a hydrodynamic diameter of both H-pectin and L-pectin with variable wt % of NaB. The hydrodynamic diameter can be reduced in a pH-dependent manner.

FIG. 4A shows a base-induced scission of pectin-producing α,β-unsaturated acids, and esters that are supposed to have antioxidant properties.

FIG. 4B shows infrared (IR) spectral analysis of pectin-CNF composite films with and without NaB, with the C═C stretch at 1600-1620 cm⁻¹ correlating with the density of unsaturated acids and esters in the samples.

FIG. 5A shows a parchment box coated with pectin-CNF composite films, e.g., H-50CNF-B containing a digital hygrometer and water dish and sealed with polyethylene film, for a modified atmosphere packaging (MAP) experiment.

FIG. 5B shows a regulation of humidity within parchment boxes over a two-week period inside a refrigerator with variable RH at 1-3° C.

FIG. 6A shows strawberries on days 1 and 21 during a MAP experiment using parchment containers with or without pectin-CNF coatings (e.g., H-50CNF-B), stored with strawberries for 3 weeks under refrigeration (1-3° C.).

FIG. 6B shows mass (moisture) loss from fruit and mass gain by packaging, relative to the original produce mass during a MAP experiment using parchment containers with or without pectin-CNF coatings (e.g., H-50CNF-B), stored with strawberries for three weeks under refrigeration (1-3° C.).

FIG. 6C shows WVP data for unsized parchment containers coated with pectin-CNF composite film (e.g., H-50CNF-B) plus uncoated control.

FIG. 6D shows moisture loss of sliced apple halves kept for seven days at ambient temperature in coated (e.g., H-50CNF-B) and uncoated parchment containers.

FIG. 7A shows the browning of sliced apple halves on days 0 and 7 when stored at ambient temperature in parchment containers with or without pectin-CNF coating (e.g., H-50CNF with 1.6 wt % NaB), sliced apple halves on days 0 and 14 when stored at 1-3° C. temperature in uncoated and coated containers with or without pectin-CNF coating (e.g., H-50CNF with 1.6 wt % NaB), and daily images (days 0-7) of sliced apple halves when stored under constant lighting at 22° C. in uncoated and coated (e.g., H-50CNF-B) parchment containers. Grid markers (small circles) guide the unbiased selection of pixels used for the conversion of RGB into L*a*b* values, with apple cores, blemishes, and aberrant lighting excluded from the analysis.

FIG. 7B shows changes in L*a*b* parameters over time mean values were derived from representative pixels in 8-bit images taken daily for sliced apple halves stored for seven days.

FIG. 7C shows changes in mean L* values for sliced apple halves stored in MAP boxes versus uncoated boxes using images in FIG. 7A.

FIG. 8A shows the degradation of pectin-CNF composite films on moist soil over five weeks. No significant differences between L-50CNF and H-50CNF composite films were observed, but composites with 14 wt % NaB degrade more slowly.

FIG. 8B shows carbon dioxide (CO₂) production during soil biodegradation of pectin-CNF composite films measured using a standardized assay (ASTM D5988).

FIG. 9A shows representative stress-strain curves of pectin-CNF-NaB composite films at 80% RH as a function of the CNF weight ratio.

FIG. 9B shows tensile strength at break (TS) for various pectin-CNF-NaB composite films at 80% RH as a function of CNF weight ratio.

FIG. 9C shows Young's modulus (Ex) of pectin-CNF-NaB composite films at 80% RH as a function of CNF weight ratio.

FIG. 9D shows elongation at break (EB) of pectin-CNF-NaB composite films at 80% RH as a function of CNF weight ratio.

FIG. 9E shows tensile toughness as defined by mean work of extension (area under stress-strain curve) based on multiple samples per specimen.

FIG. 10A shows TS of L-CNF-B composite films at 80% RH with variations in NaB loading.

FIG. 10B shows E_{Y} of L-CNF-B composite films at 80% RH with variations in NaB loading.

FIG. 10C shows EB of L-CNF-B composite films at 80% RH with variations in NaB loading.

FIG. 10D shows tensile toughness as defined by mean work of extension based on multiple samples per specimen of L-CNF-NaB composite films at 80% RH with variations in NaB loading.

FIG. 11A shows TS of L-40CNF-B composite films at 80% RH.

FIG. 11B shows E_{Y} of L-40CNF-B composite films at 80% RH.

FIG. 11C shows EB of L-40CNF-B composite films at 80% RH.

FIG. 12A shows TS of pectin-CNF-NaB composite films at 80% RH with variations in methoxyl content.

FIG. 12B shows E_{Y} of pectin-CNF-NaB composite films at 80% RH with variations in methoxyl content.

FIG. 12C shows EB of pectin-CNF-NaB composite films at 80% RH with variations in methoxyl content.

FIG. 12D shows the tensile toughness of pectin-CNF-NaB composites at 80% RH with variations in methoxyl content.

FIG. 13A shows TS of H-50CNF-B composite films at 50% RH versus 80% RH.

FIG. 13B shows E_{Y} of H-50CNF-B composite films at 50% RH versus 80% RH.

FIG. 13C shows EB of H-50CNF-B composite films at 50% RH versus 80% RH.

FIG. 13D shows the tensile toughness of H-50CNF-B composite films at 50% RH versus 80% RH.

FIG. 14 shows an FE-SEM image of dispersed CNFs prior to blending with pectin.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The term “modified atmosphere packaging” refers to the technology of modifying the composition of the internal atmosphere of a package (commonly food packages, drugs, etc.) in order to improve the shelf life.

The terms “pectin-based composite” and “pectin-based composite barrier” are used interchangeably.

The present disclosure is predicated, at least in part, on the discovery that pectin is an appealing material for biodegradable food packaging but suffers from low mechanical strength, especially at high relative humidity (RH). Nano-cellulose materials have been used to strengthen pectin-based films and packaging (Chaichi et al., Carbohydrate Polymers, 2017, 157, 167). Problems related to food spoilage include water condensation or loss, oxidation, and microbial growth. The environment around which the food is preserved is a critical factor in the preservation process. Modified atmosphere packaging creates a modified atmosphere in a package that reduces the said problems and prolongs the shelf life of food.

In view of the above, a pectin-based composite barrier, which can be used in the form of a composite film or a composite coating on food packaging material, such as food containers, is provided. Pectin is an acidic polysaccharide that can replace petroleum-based thermoplastics and prolong the shelf life of perishable food. However, pectin alone is hygroscopic and has a poor tensile strength (e.g., 4-6 MPa), limiting its utility at humidities common to moist foods. The mechanical properties of pectin can be reinforced by cellulose nanofiber (CNF). CNF can be derived from a suitable source. CNF can be derived from wood pulp.

Provided is a pectin-based composite barrier comprising (i) a pectin, (ii) a cellulose nanofiber (CNF), and (iii) a mild base selected from sodium borate (NaB) and sodium carbonate (NaC).

The pectin-based composite barrier can be a composite film or a composite coating. In some embodiments, the base selected is sodium borate (NaB). NaB is also generally known as sodium tetraborate (Na₂B₄O₇). In some embodiments, the pectin-based composite barrier is a pectin-CNF-NaB. In some embodiments, the base selected is sodium carbonate (NaC). In some embodiments, the pectin-based composite barrier is pectin-CNF-NaC. Pectin can be derived from any suitable plant source. Examples include, but are not limited to, apples, grapes, lemons, oranges, grapefruits, citrus fruits, pears, beets, potatoes, plums, and rose hips. Pectin used can be with low methoxyl density (LDM) or high methoxyl density (HDM). LDM pectin can comprise about 5% to about 50% (such as 5% to 50%) of methoxyl density. In some embodiments, the LDM pectin (L) comprises about 6.7% methoxyl density (such as 6.7%). HDM pectin (H) can comprise about 50% to about 90% methoxyl density (such as 50% to 90%). The amount of pectin and CNF present in the composite barrier can be in a weight ratio between about 1:1 to about 3:7, such as about 1:1 to 3:7, 1:1 to about 3:7 or 1:1 to 3:7. In some embodiments, the amount of pectin and CNF present in the composite can be in a weight ratio between about 80:20 to about 30:70, such as about 80:20 to 30:70, 80:20 to about 30:70 or 80:20 to 30:70. The amount of pectin present in the composite barrier can be from about 25 wt % to about 80 wt %, such as 25 wt % to about 80 wt %, about 25 wt % to 80 wt %, or 25 wt % to 80 wt %. In some embodiments, the amount of pectin present in the composite is about 25 wt %. In some embodiments, the amount of pectin present in the composite is about 30 wt %. In some embodiments, the amount of pectin present in the composite is about 34 wt %. In some embodiments, the amount of pectin present in the composite is about 40 wt %. In some embodiments, the amount of pectin present in the composite is about 46 wt %. In some embodiments, the amount of pectin present in the composite is about 50 wt %. In some embodiments, the amount of pectin present in the composite is about 60 wt %. In some embodiments, the amount of pectin present in the composite is about 70 wt %. In some embodiments, the amount of pectin present in the composite is about 80 wt %.

The pectin-based composite barrier can comprise about 17 wt % of CNF to about 70 wt % of CNF, such as 17 wt % to about 70 wt %, about 17 wt % to 70 wt %, or 17 wt % to 70 wt %. In some embodiments, the amount of CNF present in the composite is about 20 wt %. In some embodiments, the amount of CNF present in the composite is about 26 wt %. In some embodiments, the amount of CNF present in the composite is about 30 wt %. In some embodiments, the amount of CNF present in the composite is about 34 wt %. In some embodiments, the amount of CNF present in the composite is about 40 wt %. In some embodiments, the amount of CNF present in the composite is about 43 wt %. In some embodiments, the amount of CNF present in the composite is about 50 wt %. In some embodiments, the amount of CNF present in the composite is about 52 wt %. In some embodiments, the amount of CNF present in the composite is about 60 wt %. In some embodiments, the amount of CNF present in the composite film is about 70 wt %.

A suitable mild base can be used to generate antioxidant activity in the pectin-CNF barriers. Examples of mild bases include, but are not limited to, sodium carbonate (NaC) and conjugate bases derived from boric acid, diboric acid, boric anhydride, and their salts and hydrates, such as sodium borate (NaB) and sodium tetraborate decahydrate. In some embodiments, the mild base is NaB. NaB and NaC can raise pH above 8 when mixed with slurries containing pectin. NaB also can be potentially used as an antimicrobial agent. NaB and NaC can increase the antioxidant capacity of pectin and bestow an oxygen barrier to the packaging coated or fabricated with the NaB-pectin composite. NaB and NaC can generate a 4,5-enoate in pectin mixture, a chemical moiety that can trap reactive oxygen species and thus has antioxidant properties. The amount of NaB present in the pectin-based composite barrier can be up to about 15 w/w % (e.g., 15 w/w %). In some embodiments, the amount of NaB present can be from about 0.1 wt % to about 15 wt % of NaB, such as 0.1 wt % to about 15 wt %, about 0.1 wt % to 15 wt %, or 0.1 wt % to 15 wt %. In some embodiments, the amount of NaB present is 0.17 wt %. In some embodiments, the amount of NaB present is 1.6 wt %. In some embodiments, the amount of NaB present is 14 wt %.

Differences in sample composition can be designated according to pectin source, such as LDM (L) or HDM (H), a dry mass ratio of CNF relative to pectin, such as 0-70%, and NaB loading (B). For example, the composite coating L-50CNF-B consists of LDM-pectin (43 wt %), CNF (43 wt % CNF), and NaB (14 wt %). In some embodiments, the pectin-based composite barrier comprises about 43% of pectin, about 43% of CNF, and about 14% of NaB. The pectin-CNF-NaB composite barrier can have a thickness from about 0.05 mm to about 1.0 mm (such as 0.05 mm to 1.0 mm). The pectin-CNF-NaB composite film can have a thickness from about 0.10 mm to about 1.0 mm. In some embodiments, the thickness of the composite film is about 0.2 mm to about 0.5 mm. In some embodiments, the thickness of the composite film is about 0.2 mm to about 0.45 mm. In some embodiments, the thickness of the composite film is about 0.21 mm to about 0.35 mm. In some embodiments, the thickness of the composite film is about 0.24 mm to about 0.32 mm. In some embodiments, the thickness of the composite film is about 0.25 mm (such as 0.25 mm or 250 μm). The mechanical (tensile) strength of the composite film in an environment at about 75-80% RH, can be from about 5.5 MPa to about 160 MPa, such as 5.5 MPa to about 160 MPa, about 5.5 MPa to 160 MPa, or 5.5 MPa to 160 MPa. In some embodiments, the tensile strength is greater than 100 MPa. In some embodiments, the tensile strength is about 105 MPa. In some embodiments, the tensile strength is about 110 MPa. In some embodiments, the tensile strength is about 115 MPa. In some embodiments, the tensile strength is about 120 MPa. In some embodiments, the tensile strength is about 125 MPa. In some embodiments, the tensile strength is about 130 MPa. In some embodiments, the tensile strength is about 135 MPa. In some embodiments, the tensile strength is about 140 MPa. In some embodiments, the tensile strength is about 145 MPa. In some embodiments, the tensile strength is about 150 MPa. In some embodiments, the tensile strength is about 155 MPa. In some embodiments, the tensile strength is about 160 MPa. The tensile strength can vary depending on the CNF and NaB content in the composite. The composite barrier can be robust at about 75-80% RH and withstand high humidity. Food items such as fruits, vegetables, or vegetable oils can remain fresh using pectin-CNF-NaB composite films or coatings.

Provided is a method for preparing a pectin-based composite barrier, which process comprises:
a. preparing a homogenous slurry of pectin-NaB with a pectin and an aqueous solution of sodium borate (NaB);
b. blending the homogeneous slurry of pectin-NaB with a cellulose nanofiber (CNF) slurry to form a pectin-CNF-NaB slurry;
c. casting and drying the pectin-CNF-NaB slurry, whereupon the pectin-based composite barrier was prepared.

Further provided is a packaging product comprising the pectin-based composite barrier as described above. The pectin-based composite barrier comprises (i) a pectin, (ii) a cellulose nanofiber (CNF), and (iii) a mild base selected from sodium borate (NaB), and sodium carbonate (NaC). In some embodiments, the barrier comprises about 17 wt % to about 70 wt % (such as 17 wt % to 70 wt %) of CNF. In some embodiments, the barrier comprises about 30 wt % to about 70 wt % (such as 30 wt % to 70 wt %) of CNF. The amount of mild base present can be from about 0.1 wt % to about 15 wt %. In some embodiments, the amount of mild base is 0.1 wt %.

Packaging product can be any suitable packaging product that can be used to store perishable material such as food. In some embodiments, the packaging product can be a modified atmosphere packaging (MAP). Examples of packaging products include, but are not limited to, containers such as boxes, cartons, trays, bags, wrappers, and flexible packaging. The pectin-CNF-NaB composite film can extend the shelf life of perishable foods that are kept well in an environment with about 55-85% RH. The composite barrier can limit aerobic oxidation and can have MAP applications, especially for perishable food materials such as fruits, vegetables, and raw meats. The pectin-based composite barrier can maintain a relative humidity from about 55% to about 70%, such as 55 wt % to about 70 wt %, about 55 wt % to 70 wt %, or 55 wt % to 70 wt % and a water absorption of about 5 mg/cm² (such as 5 mg/cm²). In some embodiments, the pectin-based composite barrier can maintain said RH at a temperature of about 1° C. to about 3° C. The packaging product can delay the oxidative degradation of stored food products. The mild base present in the composite barrier can generate 4,5-denotes compound that can provide antioxidant capacity to the pectin-based composite barrier. In some embodiments, the pectin-based composite barrier can be a composite coating. The thickness of the composite coating for MAP can be about 50 μm (such as 50 μm).

The known reported MAP strategies involve protective gases, making the packaging process very complex and costly. Effective manipulation of the atmosphere within a package, without the introduction of external gaseous components, hinges significantly upon humidity regulation. In-package humidity levels can be influenced by factors such as the respiration rate of fresh produce, the water vapor permeability (WVP) of the packaging material, and the size of the packaging product. It is reported that reducing the oxygen concentration within a package can slow the respiration rate, thereby extending shelf life.

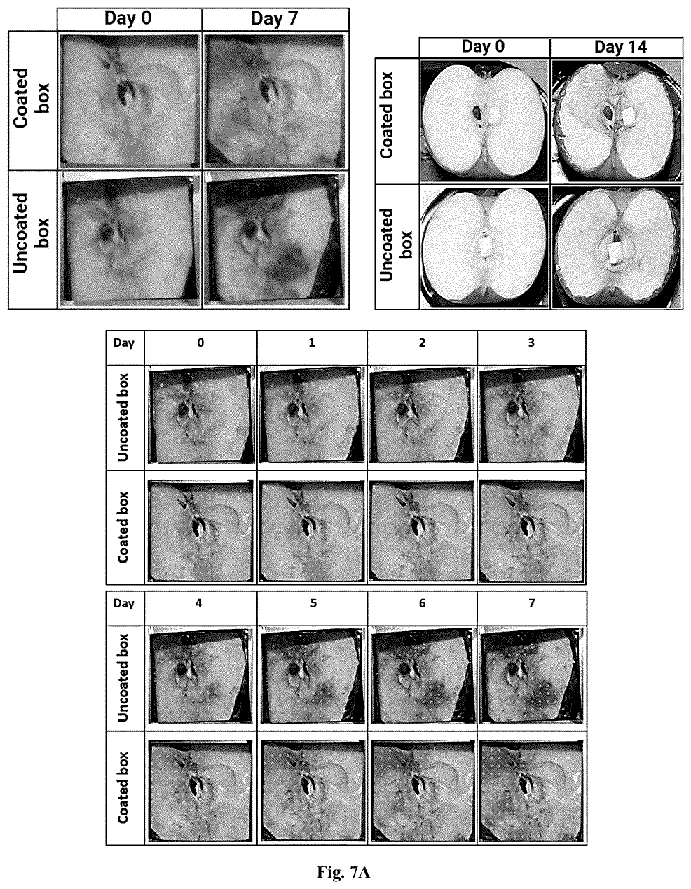

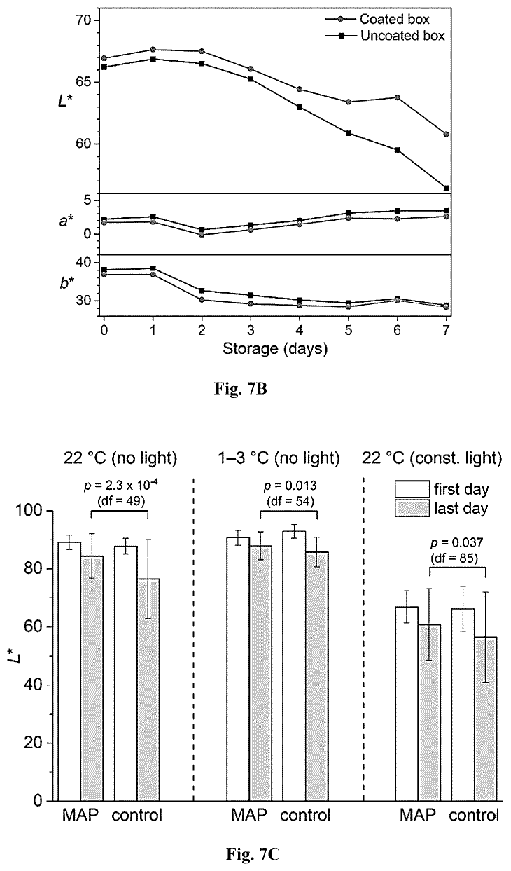

Packaging products coated with pectin-CNF-NaB composite barriers can create a modified atmosphere and have better humidity regulation, improved moisture preservation of fruits, and reduced oxidative browning relative to uncoated controls, comparing favorably with conventional plastics. Pectin-CNF-NaB composite barriers can balance water absorption and evaporation and thus can serve as a moisture reservoir and buffer against desiccation during food storage. It can protect packaged contents against oxidative deterioration while also regulating internal humidity (see FIGS. 6A, 6B, and 7A). The pectin-based composite barrier can deteriorate by standard soil biodegradation routes. The use of pectin-CNF-NaB composite barriers avoids the addition of gases that are used to achieve MAP. It was observed that the packaging product with pectin-CNF-NaB composite barrier under MAP can enhance moisture retention and reduce oxidative browning in fruits. Thus, the pectin-CNF-NaB composite barrier can delay fruit ripening, reduce microbial growth, and extend the shelf life of perishable food products.

### Examples

The following examples serve to illustrate the present disclosure. The examples are not intended to limit the scope of the claimed invention in any way.

### Materials

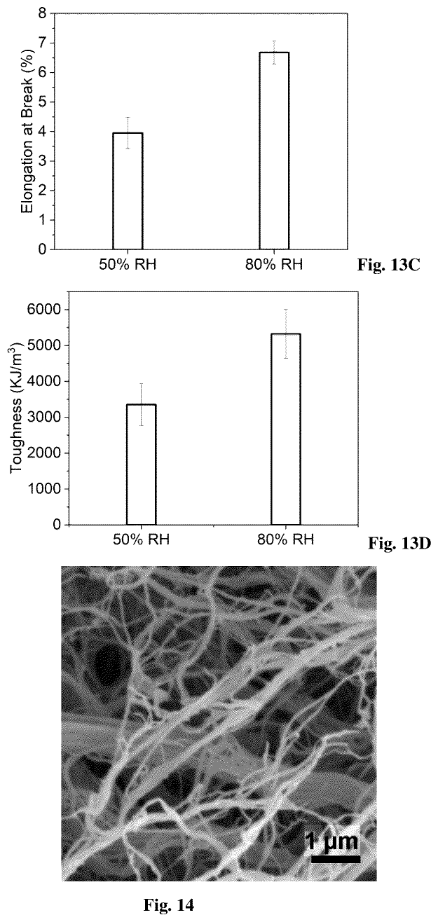

Sodium tetraborate decahydrate (Na₂B₄O₇·10 H₂O), low-density methoxylated (LDM) pectin extracted from citrus peel (6.7% methoxyl, >74% galacturonic acid (GalA)), and high-density methoxylated (HDM) pectin extracted from apple rind (50-75% methoxyl), CNFs derived from wood pulp (3 wt % solids) as 100% refined slurries using a disk grinding process, with fiber diameter and length distributions of 5-200 nm and 130-225 μm respectively (see FIG. 14 for FE-SEM image of CNFs). Organic soil was ground and sieved with a 2-mm mesh and used within 6 months of acquisition. All other reagents and solvents were obtained from commercial suppliers and used as provided.

### Abbreviations Used are:

AV: anisidine value; CNC: cellulose nanocrystal; CNF: cellulose nanofiber; E_{Y}: Young's modulus of elasticity; EB: elongation at break; GalA: galacturonic acid; HDM: high-density methoxyl; LDM: low-density methoxyl; MAP: modified atmosphere packaging; NaB: sodium borate; NaC: sodium carbonate; PE: polyethylene; PET: polyethylene terephthalate; PHA: polyhydroxyalkanoates; PLA: polylactic acid; PP: polypropylene; RH: relative humidity; stdev: standard deviation; TS: tensile strength at break; WA: water absorption; WVP: water vapor permeability; WVTR: water vapor transmission rate.

### Preparation of Composite Barriers:

Composites comprised of pectin, CNF, and/or NaB can be prepared as follows. A dispersion of 3 wt % pectin was prepared by the slow addition of pectin powder to aqueous NaB solutions (e.g., 200 mM [B] or 1.0 wt % NaB) and mixed at 600 rpm for at least 1 hour using an overhead mechanical stirrer until a homogeneous slurry was obtained. Pectin-NaB mixtures were blended with a 3 wt % CNF slurry in pre-defined dry mass ratios of pectin:CNF (100:0 to 30:70) and mixed for 1 hour until homogenous, then degassed under reduced pressure (ca. 5 torr) for 2 hours to remove trapped air. Improvements in mechanical properties were observed for pectin:CNF dry mass ratios between 80:20 and 30:70.

Pectin-CNF-NaB slurries (150 g wet weight) were cast into Teflon-coated pans (18.5×8.5 cm²) and dried in a convection oven for 12 hours at 50° C., with dry weights recorded at room temperature. The NaB content of composite films in fully dried states ranged from 0-14 wt % (NaB wt % reported without hydrates). The cast films were then placed in a humidifying chamber and conditioned above 80% RH for 48 hours at 25° C. before cutting into coupons with 50-mm gauge length for tensile testing.

### Materials Analysis and Testing

### Dynamic Light Scattering

Pectin powder (10 mg) was dispersed in 10 mL of water or aqueous NaB at 2 mM, 20 mM, or 200 mM (pH range 3.8-9.1). Samples were vortexed until fully dispersed and then allowed to stand at room temperature for 24 hours. Changes in the hydrodynamic size of colloidal pectin were measured using a Malvern Zetasizer (Nano ZS) in intensity distribution mode with refractive index of solution and absorption threshold set at 1.5470 and 0.001, respectively. Samples were measured in a disposable polystyrene cuvette (DTS 0012), following an equilibration time of 120 seconds.

### Fe-Sem Analysis:

Pectin-CNF composite films were imaged by field-emission scanning electron microscopy (SEM). Samples were mounted on carbon tape adhered to an Al pedestal and sputtered with Pt prior to imaging at an accelerating voltage of 5 kV and a working distance of 10 mm.

### Water Absorption and Transmission Analysis:

RH values in enclosed spaces were measured using battery-operated digital hygrometers. Gravimetric water absorption tests were performed according to a reported method with some modifications (Rahmadiawan et al., Journal of Composites Science, 2022, 6, Article 337). Square samples (1.3×1.3 cm²) were cut and dried for at least 24 hours at 40° C., then cooled for 30 minutes in a desiccator (<10% RH) before recording initial masses, which ranged from 48 g to 67 g. Samples were transferred into a closed chamber maintained at 80% RH and 25° C., with changes in mass recorded in triplicate over an 8-hours window. Water absorption (WA) values were calculated as follows:

$$WA ( \% ) = \frac{{m}_{f} - {m}_{i}}{{m}_{i}} \times 100 \qquad ( 1 )$$

$$Normalized WA ( g / {cm}^{2} ) = \frac{{m}_{f} - {m}_{i}}{A} \qquad ( 2 )$$

where mᵢ and m_{f} represent the initial and final sample mass (g), and A is the sample area (1.69 cm²).
Water vapor transmission rates (WVTR) were measured in accordance with ASTM E96-00. In brief, a permeability cup with an aperture of 10 cm² was filled with 5 mL deionized water and then tightly sealed by a pectin-CNF membrane (ca. 50 μm thickness). Cup mass was measured before and after storage in a humidity-controlled chamber (50% RH) at 23° C. for 24 hours to determine mass loss, which was used to calculate WVTR and water vapor permeability (WVP) as follows:

$$WVTR = \frac{Δ m}{A \times T} \qquad ( 3 )$$

$$WVP = WVTR \times \frac{n}{{P}_{o} Δ RH} \qquad ( 4 )$$

where Δm is the loss of water (g), A is the cup aperture (10⁻³ m²), t is the duration of the experiment(s), n is the film thickness (5×10⁻⁴ m), Pₒ is the partial vapor pressure at 23° C. (2808 Pa), and ΔRH is the difference in RH between the two sides of the membrane (50%).

### Oxygen Barrier (Antioxidant) Analysis:

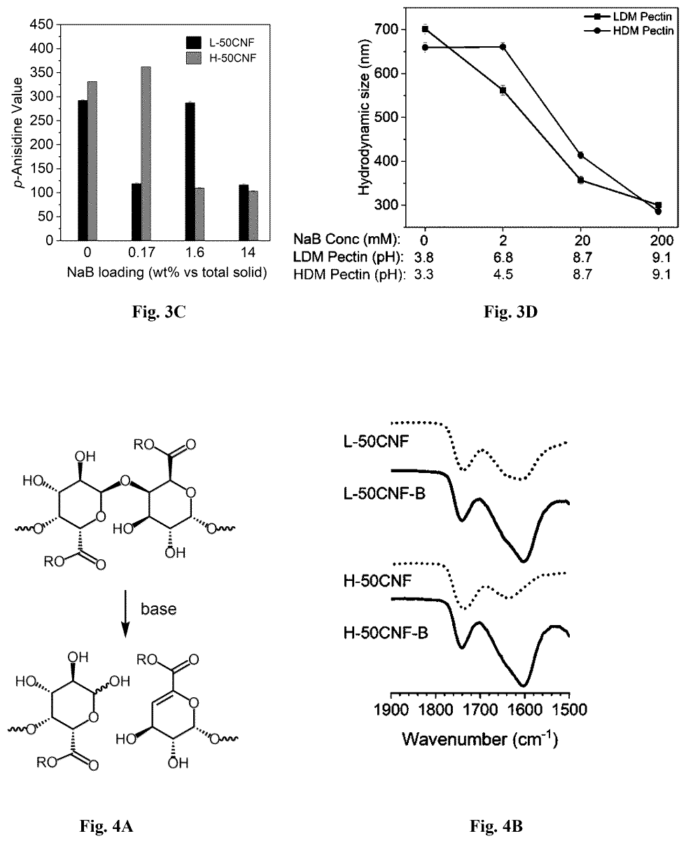

Glass vials were filled with de-aerated corn oil (5 g), sealed with pectin-CNF films, and incubated on an aluminum heating block for at least 7 days at 85° C. to accelerate oxidation, which was quantified using the p-anisidine test performed according to AOCS method Cd 18-90 with some minor modifications (Varona et al., MethodsX, 2021, 8, Article 101334). In brief, 50 mg of heated corn oil was mixed with 25 mL of 2,2,4-trimethylpentane (isooctane). A 5-mL aliquot of this solution was mixed with 1 mL of p-anisidine solution in glacial acetic acid (2.5 mg/mL) and left in the dark for 10 minutes before recording the absorbance at 350 nm on a spectrophotometer. Protection from humidity during this period is important to keep the layers from separating. Absorbances of samples (As) were measured alongside a control (blank) without anisidine (Ab) and used to calculate anisidine values (AV) according to the following equation:

$$AV = \frac{25 \times ( 1.2 As - Ab )}{m} \qquad ( 5 )$$

where m is the mass of oil in the sample (50 mg). The background absorbance (isooctane alone) was subtracted from all spectral measurements prior to analysis. AV measurements (Table 1) were normalized relative to the positive control sample (capped vial) (see FIGS. 3A-3C).

TABLE 1
Experimental p-anisidine values (AV) of oils
preserved with composite film samples (N = 3).

| | base loading | |
|---|---|---|
| Composite films | (% total solids) | AV |
| Capped | — | 77.4 ± 2.6 |
| Uncapped | — | 323.2 ± 2.7 |
| L-50CNF | 0 | 178.5 ± 1.7 |
| H-50CNF | 0 | 351.4 ± 2.6 |
| L-50CNF-B | 14 | 78.5 ± 1.1 |
| H-50CNF-B | 14 | 72.1 ± 2.0 |
| LDM-NaB | 14 | 69.0 ± 1.7 |
| LDM-NaC | 14 | 72.2 ± 1.6 |
| HDM-NaB | 14 | 72.9 ± 0.6 |
| HDM-NaC | 14 | 71.8 ± 1.1 |
| L-50CNF | 0 | 235.1 ± 1.4 |
| L-50CNF | 0.17 | 79.7 ± 2.0 |
| L-50CNF | 1.6 | 256.5 ± 3.5 |
| L-50CNF | 14 | 73.9 ± 2.2 |
| H-50CNF | 0 | 284.0 ± 0.1 |
| H-50CNF | 0.17 | 324.6 ± 0.3 |
| H-50CNF | 1.6 | 71.6 ± 1.0 |
| H-50CNF | 14 | 65.6 ± 1.2 |

### Tensile Testing:

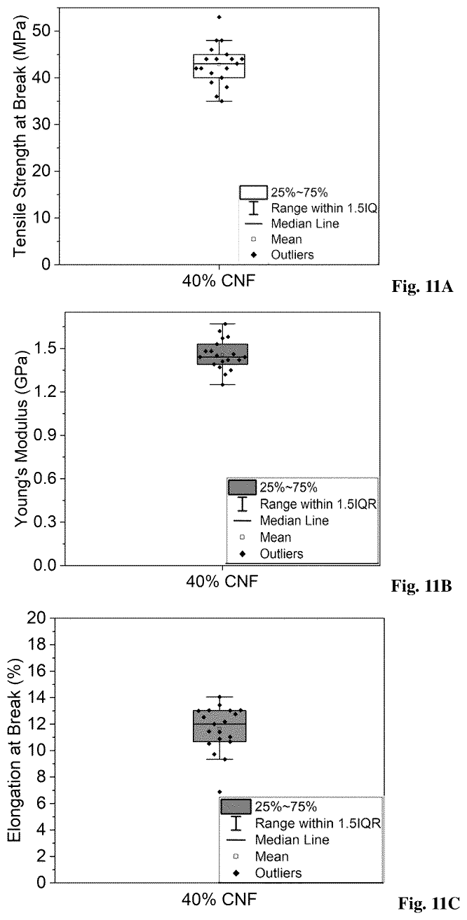

All samples were conditioned for two days above 80% RH before cutting into standard type I coupons with 50-mm gauge length in accordance with ASTM D638. Mean coupon thicknesses were measured by a digital micrometer with 4-μm resolution, using ten points selected at random along the gauge length of the dumbbell-shaped specimens. Coupons were maintained at 80% RH before tensile testing. Tensile strength at break (TS), Young's modulus (Ex), and elongation at break (EB), were analyzed by a universal tester (maximum load 5 kN, grip distance 115 mm) with a preload force of 1 N and a crosshead speed of 6 mm/min. Film toughness was calculated by measuring the area under the stress-strain curve. Multiple specimens (N≥8) were tested with data outliers removed using box plot analysis to reduce standard deviations (FIGS. 11A-11C).

### Modified Atmosphere Packaging Studies

### Construction of Pectin-CNF Coated Parchment Boxes:

Pectin-CNF-NaB composites (50:50 HDM-pectin:CNF with 14 wt % or 1.6 wt % NaB; 150 g wet weight) were prepared as slurries as described above. Pectin-CNF-NaB slurries were cast evenly onto unsized sheets (21.0× 29.7 cm²) of parchment paper (grammage 90 g/m²) and dried overnight in a convection oven at 40° C. The MAP coating had a final mean thickness of 50 μm and was conditioned in a humidifying chamber for one day above 80% RH then folded into a topless, four-sided box with dimensions of 10.2×10.2×5.1 cm³ (4× 4×2 in³). Fruits were scaled inside the box by a transparent polyethylene film with minimum contact to the box faces to support air exchange through the sides. The composite coatings were comprised of 43 wt % pectin, 43 wt % CNF, and 14 wt % NaB.
Humidity Regulation with Pectin-CNF Coated Packaging:
A dish of deionized water (20 mL) and a digital hygrometer were sealed in coated and uncoated parchment containers covered with polyethylene films as described above. The sealed containers were placed in a standard kitchen refrigerator with an internal temperature and humidity range of 1-3° C. and 49-64 RH %, respectively. The RH % inside sealed containers was recorded once daily over a 2-week period. A similar study was performed using strawberries (200 g) purchased from a local supermarket and sealed in coated and uncoated parchment containers as described above, which were kept in the refrigerator for 3 weeks and monitored once daily for changes in RH %.

### Oxidative Browning of Sliced Apples:

Apples purchased from a local supermarket were sliced into halves under an inert (nitrogen) atmosphere, then sealed immediately in MAP boxes as described above.
Images of apple halves were captured from video recordings taken with a stationary digital camcorder. Overhead lighting was provided by a 5000K LED corncob bulb positioned equidistant from experimental and control specimens (FIG. 7A). Apple halves were sealed in MAP boxes and stored in the dark at room temperature for one week or under refrigeration (1-3° C.) for two weeks. Specimens were imaged in unwrapped boxes at the beginning and end of the experiment on a fixed lighting stage, as described above. Browning studies of sliced apple halves were also conducted at room temperature for one week under constant lighting; daily images were captured by introducing a 4×5 cm² glass window into the polyethylene film for maximum light transmission. Image analysis was performed using ImageJ by applying a grid overlay for unbiased pixel selection in validated areas (Mavlan et al., Cellulose, 2023, 30, 8805-8817). Digital processing of multiple areas yielded aggregate RGB values that were converted into L*a*b* values using an online color conversion tool; a one-way t-test was used to confirm significant differences.

### Biodegradation Studies:

Biodegradation analysis based on mineralization (CO₂ production) was performed in accordance with ASTM D5988 (ASTM, 2012). HDM-pectin-CNF samples with or without 1.6 wt % NaB (100 mg C content) were powderized and mixed with dry soil granulated to 2 mm (100 g), which was moistened to 80% of its water holding capacity (20.5 g H₂O). Samples (N=3) were maintained in 2-L glass desiccator jars containing beakers of water (50 mL) and 0.5 N KOH (20 mL) to maintain constant RH and absorb CO₂, respectively. The jars were stored in the dark at 25° C. for seven weeks and opened once per week for aeration and measurement of CO₂ data by acid-base titration. Self-standing films of LDM- and HDM-pectin blended with one equal portion of CNF with or without NaB (mass ratios of pectin:CNF:NaB=43:43:14 or 50:50:0, respectively) were prepared as described above. Visual analysis of biodegradation was also performed on free-standing pectin-CNF films using soil samples (100 g) collected from local grounds, which were placed in plastic containers then moistened with 10 g of water, similar to that described in a reported procedure (Ren et al., Food Hydrocolloids, 2022, 129, Article 107643). Pectin-CNF samples were placed on top of moist soil with exposure to air; containers were covered and stored in a cabinet at room temperature for up to 5 weeks, with photos taken weekly.

### Results:

### Preparation of Pectin-CNF Composite Films:

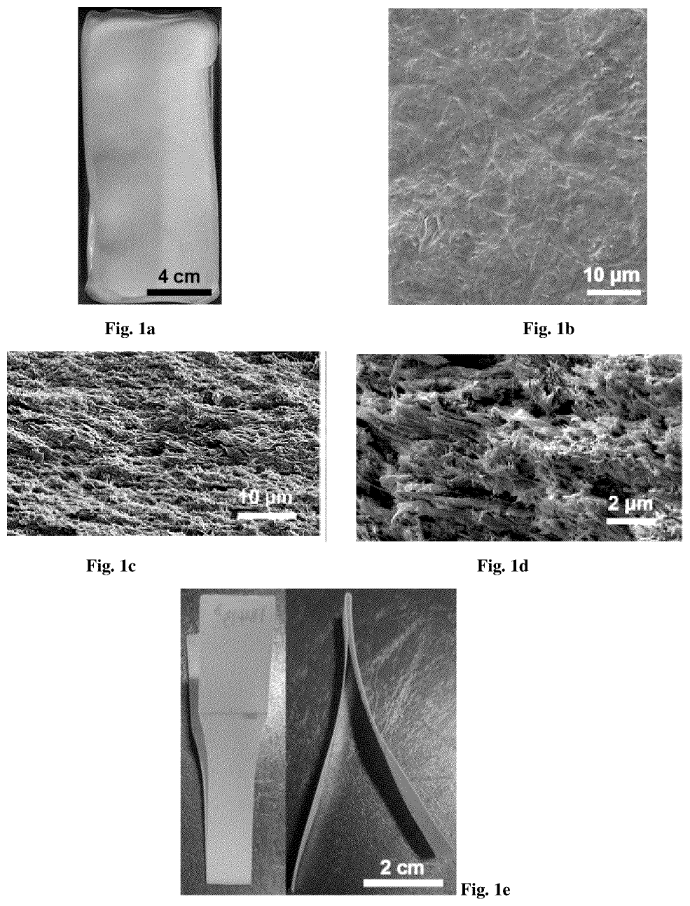

Pectin-CNF-NaB films were typically prepared by blending slurries of 3% w/v pectin in 0.2 M borate, such as 1% w/v NaB with 3 wt % CNF in variable ratios. Differences in sample composition were designated according to pectin source (LDM (L) or HDM (H)), dry mass ratio of CNF relative to pectin (0-70%), and NaB loading (B). For example, the dry mass ratio of composite coating L-50CNF-B is LDM-pectin 43 wt %, CNF 43 wt % CNF (50:50 pectin:CNF, and NaB 14 wt %, whereas that for H-60CNF is HDM-pectin 40 wt % and CNF 60 wt %. It was noted that viscosity of the mixtures increased proportionally with CNF content, with a practical upper limit reached at 30:70 pectin:CNF. Homogenized pectin-CNF slurries were degassed under vacuum to remove trapped air bubbles, then cast into molds and dried in a convection oven at 50° C. The resulting films had a mean thickness of 250 μm (see Tables 2-4) and were visibly smooth (FIGS. 1a-1B), although inspection by SEM revealed fiber strands near the surface (FIG. 1b). SEM analysis of fractured interfaces confirmed that CNFs were well dispersed inside the composite without bundling or aggregation, implying the blends were fully homogenized (FIGS. 1C-1D). Free-standing pectin-CNF films were initially brittle, but their ductility increased dramatically after conditioning at 80-90% RH at ambient temperature. The absorbed moisture served as a natural plasticizer that allowed the films to be cut into coupons for tensile testing or folded without fracturing (FIG. 1E). Pectin-CNF films could also be applied as coatings onto paper substrates with drying and conditioning, as described above, for subsequent studies on modified atmospheric packaging.

TABLE 2
Mechanical properties of LDM-pectin-CNF films prepared with 14 wt % NaB

| | Samples | | | | |
|---|---|---|---|---|---|
| CNF content^{a} | (outliers)^{b} | Thickness (mm) | TS (MPa) | E_{Y} (GPa) | EB (%) |
| L-0CNF-B | 8 (0) | 0.306 ± 0.028 | 5.8 ± 2.2 | 0.34 ± 0.03 | 5.36 ± 1.53 |
| L-10CNF-B | 13 (1) | 0.271 ± 0.011 | 18.9 ± 3.1 | 0.90 ± 0.04 | 5.81 ± 2.25 |
| L-20CNF-B | 20 (0) | 0.250 ± 0.011 | 27.8 ± 2.7 | 0.92 ± 0.06 | 13.02 ± 1.74 |
| L-30CNF-B | 20 (2) | 0.257 ± 0.015 | 34.1 ± 3.2 | 1.11 ± 0.08 | 12.33 ± 1.27 |
| L-40CNF-B | 19 (2) | 0.258 ± 0.022 | 42.6 ± 3.4 | 1.43 ± 0.08 | 11.88 ± 1.38 |
| L-50CNF-B | 22 (3) | 0.242 ± 0.024 | 49.9 ± 7.7 | 1.77 ± 0.12 | 11.44 ± 3.21 |
| L-60CNF-B | 12 (0) | 0.251 ± 0.027 | 73.3 ± 2.9 | 2.28 ± 0.21 | 13.89 ± 1.77 |
| L-70CNF-B | 12 (2) | 0.256 ± 0.029 | 117.7 ± 8.2 | 4.29 ± 0.28 | 5.69 ± 0.74 |

^{a}14 wt % NaB.
^{b}Outliers removed from data analysis.

TABLE 3
Effect of NaB content on the mechanical properties of LDM-pectin-CNF films

| CNF content | NaB (wt %) | Thickness (mm) | TS (MPa) | E_{Y} (GPa) | EB (%) |
|---|---|---|---|---|---|
| L-40CNF | 0 | 0.206 ± 0.013 | 86.8 ± 5.4 | 2.79 ± 0.16 | 10.56 ± 1.25 |
| L-40CNF | 0.17 | 0.209 ± 0.026 | 104.3 ± 9.7 | 3.58 ± 0.22 | 10.06 ± 1.20 |
| L-40CNF | 1.6 | 0.206 ± 0.021 | 88.6 ± 7.7 | 2.89 ± 0.16 | 11.6 ± 0.91 |
| L-40CNF | 14 | 0.258 ± 0.022 | 42.6 ± 3.4 | 1.43 ± 0.08 | 11.88 ± 1.38 |
| L-50CNF | 0 | 0.207 ± 0.027 | 109.2 ± 7.7 | 3.58 ± 0.20 | 11.15 ± 0.70 |
| L-50CNF | 0.17 | 0.195 ± 0.023 | 101.2 ± 8.2 | 3.05 ± 0.15 | 12.47 ± 1.12 |
| L-50CNF | 1.6 | 0.206 ± 0.018 | 99.4 ± 4.4 | 3.29 ± 0.14 | 10.56 ± 0.48 |
| L-50CNF | 14 | 0.242 ± 0.024 | 49.9 ± 7.9 | 1.77 ± 0.12 | 11.44 ± 3.30 |
| L-60CNF | 0 | 0.198 ± 0.021 | 146.0 ± 7.8 | 5.27 ± 0.26 | 8.09 ± 0.88 |
| L-60CNF | 0.17 | 0.206 ± 0.020 | 137.4 ± 8.1 | 4.85 ± 0.23 | 7.82 ± 1.00 |
| L-60CNF | 1.6 | 0.203 ± 0.025 | 149.7 ± 10.1 | 5.32 ± 0.10 | 6.27 ± 1.20 |
| L-60CNF | 14 | 0.251 ± 0.027 | 73.3 ± 2.9 | 2.28 ± 0.21 | 13.89 ± 1.77 |

TABLE 4
Effect of methoxy density on the mechanical properties of pectin-CNF films

| Pectin type | Sample ID^{a} | Thickness (mm) | TS (MPa) | E (GPa) | EB (%) |
|---|---|---|---|---|---|
| HDM | H-0CNF-B | 0.387 ± 0.080 | 10.7 ± 1.7 | 0.40 ± 0.06 | 7.42 ± 2.11 |
| | H-50CNF | 0.221 ± 0.022 | 104.7 ± 9.6 | 3.42 ± 0.11 | 12.40 ± 1.66 |
| | H-50CNF-B | 0.256 ± 0.036 | 114.0 ± 9.0 | 3.94 ± 0.28 | 6.68 ± 0.40 |
| LDM | L-0CNF-B | 0.306 ± 0.028 | 5.8 ± 2.2 | 0.34 ± 0.03 | 5.36 ± 1.53 |
| | L-50CNF | 0.258 ± 0.022 | 109.2 ± 7.7 | 3.58 ± 0.20 | 11.15 ± 0.70 |
| | L-50CNF-B | 0.242 ± 0.024 | 49.9 ± 7.9 | 1.77 ± 0.12 | 11.44 ± 3.30 |

^{a}B = 14 wt % NaB.

### Water Absorption and Permeability:

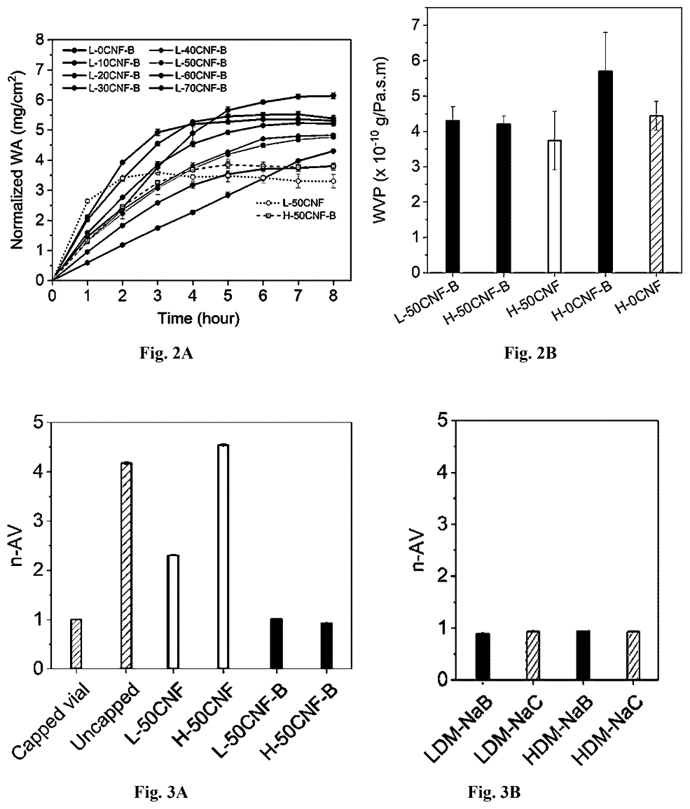

The WA and WVP values of pectin and pectin-CNF composite films were measured according to ASTM E-96 are presented in FIGS. 2A and 2B. Dry films fabricated with LDM pectin (L-50CNF-B) exhibited greater moisture uptake compared to films derived from HDM pectin (H-50CNF-B), which is expected as HDM pectin is relatively less hydrophilic. On the other hand, increasing CNF content resulted in a decline in WA rate and saturation, despite reports of its higher water-holding capacity relative to pectin. The normalized WA of most samples reached saturation between 4-8 hours except for films without NaB (L-50CNF), which plateaued after 2 hours, indicating that borate salts also contribute toward the WA of pectin-CNF composites. Moisture exchange is an important consideration in the design of MAP, which is intended for fruits and vegetables. In particular, breathability helps to avoid condensation buildup from produce transpiration that can promote microbial growth if overall water loss can be regulated. WVP values of select pectin-CNF films with an external RH of 50% (4-6×10⁻¹⁰ g/Pa·s·m, FIG. 2B) was measured and found their moisture exchange rates to be orders of magnitude lower than that of kraft paper (˜3×10⁻⁴ g/Pa·s·m) but comparable to other polysaccharide-based films (1-10×10⁻¹⁰ g/Pa·s·m) and considerably higher than films of standard thermoplastics or bioplastics such as PLA and PHA (1-3×10⁻¹¹ g/Pa·s·m). The pectin films reinforced with CNF reduced WVP by roughly 30% relative to pectin films without CNF (e.g., H-50CNF-B vs. H-0CNF-B) in accord with other studies, whereas the addition of borate appeared to increase WVP (H-0CNF-B vs. H-0CNF) and the methoxy content of pectin did not have a significant effect (H-50CNF-B vs. L-50CNF-B). As discussed below, the balance between water absorption and evaporation determines the ability of pectin-CNF composites to serve as a moisture reservoir and buffer against dessication during fruit storage.

### Antioxidant Capacity:

Exposing fresh fruits and vegetables to oxygen is well known to increase respiration in produce, depleting stored carbohydrates and triggering a variety of processes that can lead to the deterioration of color, taste, or texture. Packaging materials with high oxygen barriers can lower respiration from produce, however these also reduce WVP and are unable to prevent the buildup of excessive moisture. An alternative strategy is to endow packaging materials with natural antioxidants, an idea that has become increasingly popular in recent years. In this regard, pectin-CNF-NaB composites have untapped potential to protect packaged contents against oxidative deterioration while also regulating internal humidity.

The antioxidant capacity of pectin-CNF-NaB films were evaluated using normalized p-anisidine values (n-AV), a simple and practical spectrophotometric assay based on the aerobic degradation of unsaturated oils. This standardized method is complementary to that based on peroxide values which has been used by others for a similar purpose, but has the benefit of quantifying secondary oxidation products (aldehydes and dienals) that accumulate over time rather than relying on peroxide species with limited lifespans. Glass vials containing degassed corn oil were covered with pectin-CNF membranes then heated for several days at 85° C., with the premise that lower AVs indicate superior oxygen barriers. Samples protected by pectin-CNF films with 14 wt % NaB loadings (H- and L-50CNF-B) produced the lowest AVs and were nearly identical to vials protected with a thick plastic cap (Ctrl⁺; FIG. 3A), indicating these membranes had useful oxygen barrier properties and offer good protection against oxidative degradation. In contrast, pectin-CNF films prepared without NaB (H- and L-50CNF) afforded much higher n-AVs and close to that measured for an uncapped oil sample (Ctrl⁻), suggesting little or no antioxidant capacity. It is worth mentioning that samples covered with H-50CNF or exposed to the air were visibly oxidized even before p-anisidine treatment.

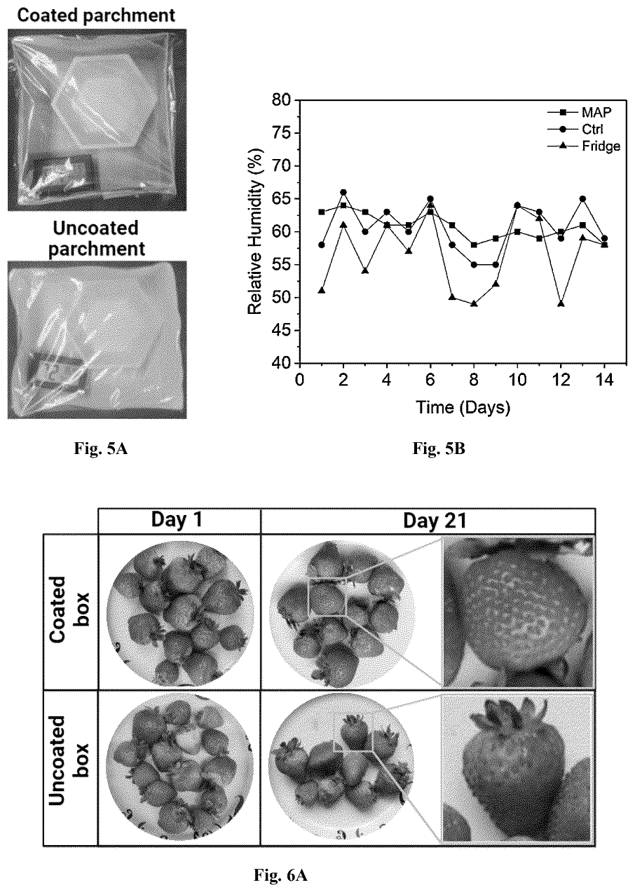

There is considerable ambiguity surrounding the antioxidant capacity of pectin-derived materials. Pectin is a second-generation feedstock derived from fruit processing waste, so it may contain phenolics with antioxidant qualities, yet pectin-based composites developed for this purpose are typically supplemented by antioxidants extracted from other sources. On the other hand, pectins obtained from commercial sources do not exhibit antioxidant activity on their own, as demonstrated by pectin-CNF films without NaB (FIG. 3A). The antioxidant properties of pectin-based composites with NaB are most likely derived from α,β-unsaturated acids and esters generated by the base-induced scission of GalA chains (Renard and Thibault, 1996, Carbohydrate Research, 286, 139-150) (FIG. 4A). The unsaturated oligosaccharides generated by enzymatic degradation have been found to be better radical scavenging activity than untreated pectin, supporting the role of 4,5-denote moiety in trapping reactive oxygen species. This hypothesis was also supported by the infrared (IR) analysis of pectin-CNF composites containing NaB, which produced a much stronger C═C stretching peak at 1600-1620 cm 1 than in composites without NaB (FIG. 4B). Additional studies support that the generation of unsaturated esters and acids and their subsequent antioxidant activities: (i) the hydrodynamic size of colloidal HDM- and LDM-pectin can be reduced in a pH-dependent manner (FIG. 3D); (ii) substituting NaB in pectin-CNF composites with sodium carbonate (NaC) yields films having similarly high antioxidant capacity (FIG. 3b); (iii) pectin-CNF films with NaB loadings between 0.17 wt % and 14 wt % show a base-dependent decrease in n-AV values (FIG. 3c). H-50CNF with 1.6 wt % NaB had similar antioxidant properties as H-50CNF with 14 wt % NaB, whereas a film with 0.17 wt % NaB yields an AV value similar to H-50CNF without NaB. Surprisingly, L-50CNF with 0.17 wt % NaB exhibits an anomalously high antioxidant capacity (low n-AV), although L-50CNF with 1.6 wt % NaB and H-50CNF with 0.17 wt % NaB offer little protection. It was noted that the L-50CNF slurry with 0.17 wt % NaB prior to film casting had a pH of 3.9, suggesting the possibility of autocatalytic enoate formation by C5 carboxylic acids. Regardless of the mechanism, our studies show that adding NaB into pectin-CNF endows the composite with antioxidant properties that can be used to preserve foodstuffs from oxidative spoilage.

### Modified Atmospheric Packaging (MAP):

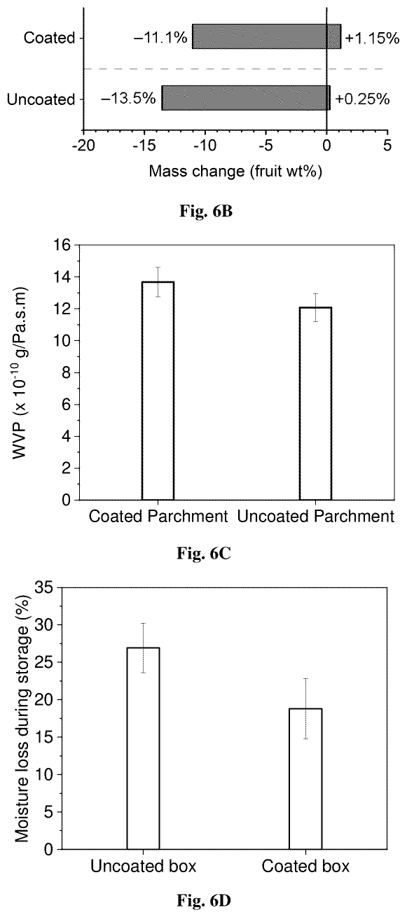

Current MAP strategies involve the use of protective gases, which makes the packaging process very complex and costly (Czerwinski et al., Coatings 11:1504 (2021)). For perishable fruits and vegetation, humidity regulation is an important factor in MAP: moisture levels can be influenced by the respiration rate of fresh produce, WVP of the packaging material, and packaging volume. Reduction in oxygen level is also desirable as it can slow the respiration rate of fresh produce, thereby extending shelf life. Excessive in-package moisture leads to water condensation that can promote microbial spoilage; contributing factors include the respiration rate of fresh produce, packaging material with low WVP, and packaging headspace. Efforts to control excessive humidity often involve materials that actively absorb moisture, but their overuse can also lead to produce desiccation and wilting. A breathable MAP material with moderate WVP can circumvent the issue of condensation buildup caused by produce transpiration; however, a reduction in free oxygen is also desirable to decrease respiration and further extend shelf life. The use of pectin-CNF barriers was investigated to address both humidity regulation and decreased oxidative deterioration. MAP applications were explored using H-50CNF-B, which was cast and dried as 50-μm films onto unsized parchment paper. The pectin-CNF coating adhered well to the parchment but also shrank while drying; warping was reduced by conditioning coated substrates above 80% RH, followed by 24 hours outside the chamber with an applied load to maintain flatness. H-50CNF-B coated parchments and uncoated controls were cut and folded into topless boxes, with contents sealed inside using a polyethylene film over the top but without covering the sides (FIG. 5a).

### Humidity Regulation During Refrigeration:

To test the potential for MAP applications, H-50CNF-B was cast and dried as 50-μm coatings onto unsized parchment paper. Coated and uncoated parchment boxes were scaled with a dish of water and digital hygrometer and placed in a standard kitchen refrigerator set at 1-3° C., with daily RH monitoring inside and outside the boxes for two weeks (FIG. 5b). Variations in RH within the parchment boxes were then collated with changes in RH within the refrigerator space, which varied between 48 and 64%. The RH inside the H-50CNF-B-coated box was maintained within a range of 6% over the two-week period, whereas the RH inside the uncoated box was less controlled with a range of 11%. Pearson correlations based on daily RH values (n=14) indicated the H-50CNF-B-coated box was much less sensitive to external humidity fluctuations than the uncoated package (R=0.20 and 0.86 respectively, p=0.05), meaning that the H-50CNF-B coating was chiefly responsible for humidity regulation whereas the parchment alone offered low protection. By regulating their internal environment, pectin-CNF coated MAP boxes can protect their contents from premature desiccation caused by sudden drops in humidity. The controlled RH during refrigeration also protects the produce from moisture buildup that can promote microbial growth.

### Preservation of Refrigerated Strawberries:

Humidity regulation during refrigeration is valuable for preserving fresh produce, which can be spoiled either by excessive moisture (promoting microbial growth) or by desiccation. To illustrate the moisture-preserving capacity of H-50CNF-B, approximately 200 g of strawberries were packaged into coated or uncoated parchment boxes and stored under refrigeration for three weeks (FIG. 6A). Fruits stored in the MAP box were firmer and more lustrous than those stored in the uncoated box which had deteriorated in both aspects, reflecting a higher degree of respiration and transpiration. These observations correlated well with the extent of moisture migration and retention as measured by mass changes in the produce and packaging (FIG. 6B). Strawberries stored in the MAP box experienced less mass change (11.1% loss) than those in the uncoated box (13.5%). Furthermore, over 10% of the moisture released by the fruit was captured and retained by the MAP box, whereas less than 2% was retained by the uncoated box. The WVP of coated and uncoated parchment also did not show any significant differences (FIG. 6C). Thus, the humidity regulation is the main determining factor for reducing moisture loss from strawberries, supported by moisture retention by the H-50CNF-B-coated parchment. The enhanced moisture preservation by H-50CNF-B-coated boxes was replicated using sliced apples stored for 7 days in ambient conditions, with similar outcomes (18.8% mass loss for MAP vs. 26.9% for control, FIG. 6D). It was presumed that water released from fruit is partially absorbed by the coating due to the hygroscopic nature of pectin and NaB when RH is below 80%. Moisture retention by the packaging is not related to differences in water permeability, as H-50CNF-B-coated parchment has a slightly greater WVP than that of uncoated control. The MAP-enhancing qualities of pectin-CNF-NaB composites may offer some advantages over other hygroscopic materials: for example, inorganic salts may be highly effective at removing excess moisture from packaged fruits and vegetables, but their capacity for water absorption also accelerates moisture loss and desiccation. In contrast, H-50CNF-B serves as a humidity buffer that can maintain a narrow RH range under refrigeration (FIG. 4), and its antioxidant capacity effectively lowers respiration, which contributes to fruit mass loss.

### Reduced Browning of Sliced Apples:

Another desirable MAP application is the reduction of oxidative browning commonly observed with the aerobic exposure of cut fruit. Enzymatic browning can be measured by colorimetric methods in CIELAB color space, particularly by the use of L* as a brightness parameter to evaluate discoloration. While luminance is typically measured using dedicated chromameters, contemporary image analysis permits pixels with standard RGB values to be converted into L*a*b* parameters. This provides a straightforward approach for quantifying fruit discoloration using conventional digital videography with constant lighting and for evaluating the possible use of pectin-CNF coated packaging to delay apple browning.
Sliced apple halves were placed inside of coated and uncoated parchment boxes and sealed with polyethylene film, then stored for one week at ambient temperature either in the dark or with constant light exposure, or for two weeks in the refrigerator (1-3° C.). In all cases, apple halves in the MAP boxes experienced significantly less discoloration than those in uncoated boxes (FIG. 7a). The latter samples experienced a significant decline in mean L* values, which was confirmed by one-tailed t-test analyses using subpopulations of pixelated data taken on the last day of the experiment (FIG. 7C). The role of oxygen exchange in browning was confirmed by wrapping both boxes in polyethylene, with only a modest loss in L* after a week of storage and no significant difference between samples (p=0.42; df=80). In summary, pectin-CNF-NaB films improved the preservation of perishable fruits as demonstrated with refrigerated strawberries, with added protection from oxidative degradation as supported by studies with corn oil and sliced apples. Given the limited thickness of these coatings (50 μm), further improvements in MAP and food preservation by constructing packages directly with pectin-CNF-NaB composites was anticipated.

### Biodegradation of Pectin-CNF Films:

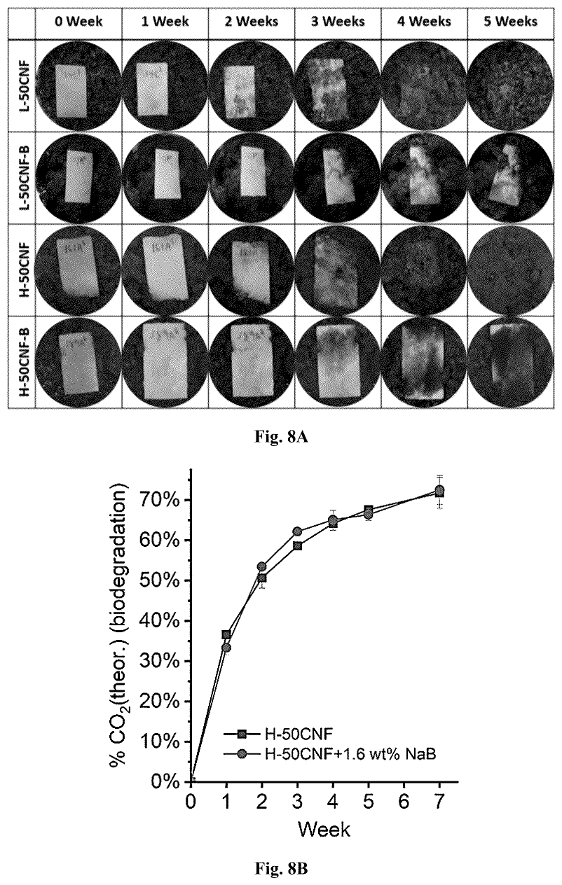

Materials for disposable packaging should be biodegradable as well as biorenewable, particularly if intended for use with perishable goods. The soil biodegradability of pectin-CNF composites was evaluated by monitoring films placed on top of moistened soil over a 5-week period as well as by a standardized assay (ASTM D5988) (FIG. 8). L-50CNF and H-50CNF films prepared without NaB show visible signs of deterioration by Week 1 and near-complete degradation by the end of Week 5 (FIG. 8a). For pectin-CNF composites with NaB (L-50CNF-B and H-50CNF-B), the rate of deterioration was slower, with roughly 50% remaining after Week 5, but eventually, all films were completely degraded. In either case, the methoxy content in pectin had no discernible impact on biodegradation rates. This study indicated that NaB acts as a mild preservative that can delay substrate digestion by soil microorganisms, as borate salts are known to have modest bacteriostatic properties against several types of pathogenic bacteria. To address this issue, the standardized assay was performed by mixing soil and granulated H-50CNF with or without 1.6 wt % NaB, which was monitored for CO₂ production. In this case, no significant differences in biodegradation were observed, with both samples producing >70% theoretical CO₂ by Week 7 (FIG. 8b). The biodegradability of pectin-CNF-based packaging is an example of how single-use materials can be designed for enhanced function and sustainable development at the same time.

### Mechanical Properties of Pectin-CNF Composite Films:

Pectin-CNF composites also have the potential as free-standing packaging materials, given sufficient structural integrity and robustness to environmental variables. Mechanical strength is of primary importance: with regard to MAP, composites must provide adequate tensile strength (TS) and toughness and maintain structural integrity at humidities relevant to food storage applications. Evaluated the mechanical properties of various pectin-CNF composites, whose TS and tensile toughness at 80% RH are comparable to other types of composites based on bioplastics such as PLA and PBAT. Pectin-CNF coupons with thicknesses of approximately 200 μm (FIG. 1C) were maintained at 80% RH prior to uniaxial tensile testing (ASTM D638), which yielded trends in tensile strength (TS) and Young's modulus (Ex), elongation at break (EB), and tensile toughness, as well as insights into the effects of NaB loading and methoxyl content.

### Effect of CNF Content on Mechanical Properties at 80% RH:

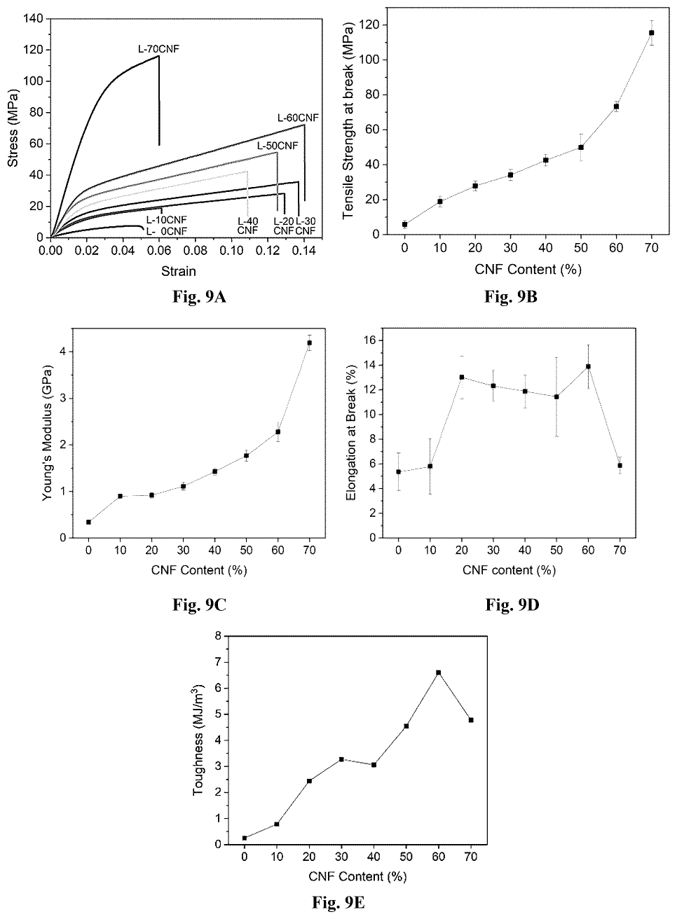

The mechanical strength of pectin-CNF-B composites generally improves with CNF content, which could be varied between 0% and 70% weight ratio with pectin (FIG. 9A and Table 2). TS increases linearly with CNF up to 50 MPa at 50% CNF for L-50CNF-B then steepens to a maximum of 115 MPa at 70% CNF for L-50CNF-B (FIG. 9B). Similarly, a monotonic rise in E_{Y} is observed up to 2.3 GPa at 60% CNF for L-60CNF-B with a steep increase to 4.2 GPa at 70% CNF for L-70CNF-B (FIG. 9C). Both of these trends indicate efficient stress transfer in CNF-reinforced pectin, and present some of the highest values to date for pectin-CNF composites: the maximum TS is comparable to that reported for pectin composites reinforced with BNC (Gu, J. et. al, 2014, Cellulose, 21, 275-289) and far higher than those reported for pectin reinforced with CNCs. CNF can also improve material ductility and toughness: pectin films (Pectin-NaB) without CNF are surprisingly brittle at 80% RH with stress failure below 5.4%, however EB more than doubles when reinforced with 20% CNF and remains high up to 60% CNF (FIG. 9D). Tensile toughness (work of extension) increases commensurately and reaches a maximum at 60% CNF (FIG. 9E), but ductility is lost at 70% CNF with a drop in EB below 6% and a subsequent decrease in toughness for L-70CNF-B. Fiber-reinforced composites with high CNF loadings are known to be less ductile (Schaqui et. al., 2011 Soft Matter, 7, 7342-7350), but the sharp difference between 60 and 70% CNF is unexpected and suggests structural heterogeneity within the composite. In this regard, it is worth mentioning that the L-70CNF-B slurry was much more viscous than those with lower CNF loadings, which may limit its homogenization prior to sample preparation and affect sample quality.

### Effect of NaB and Methoxyl Content:

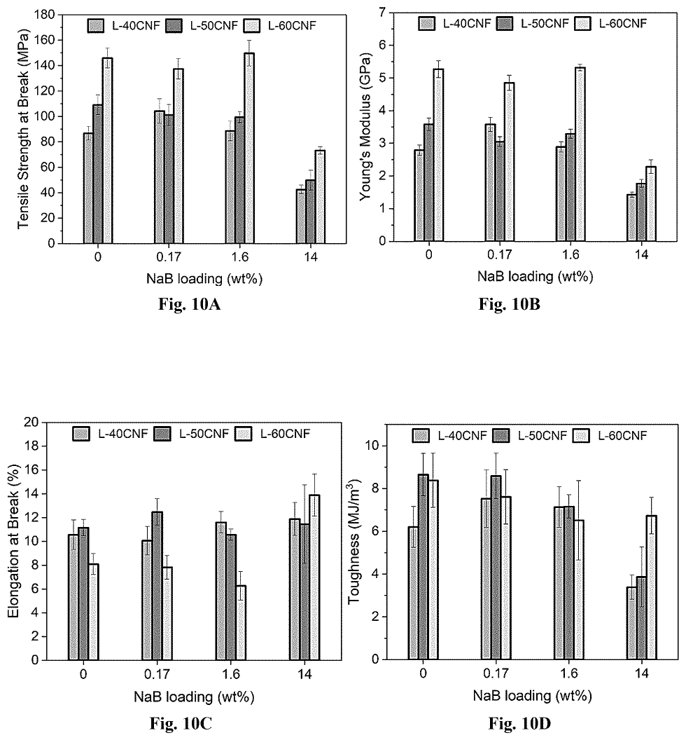

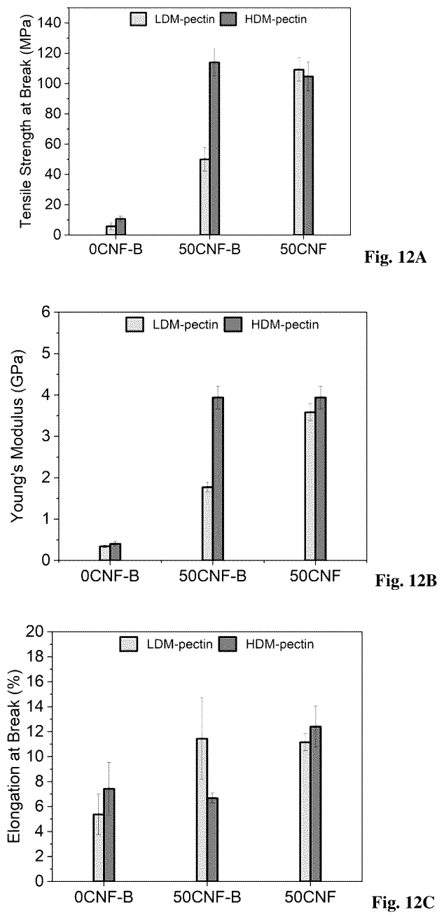

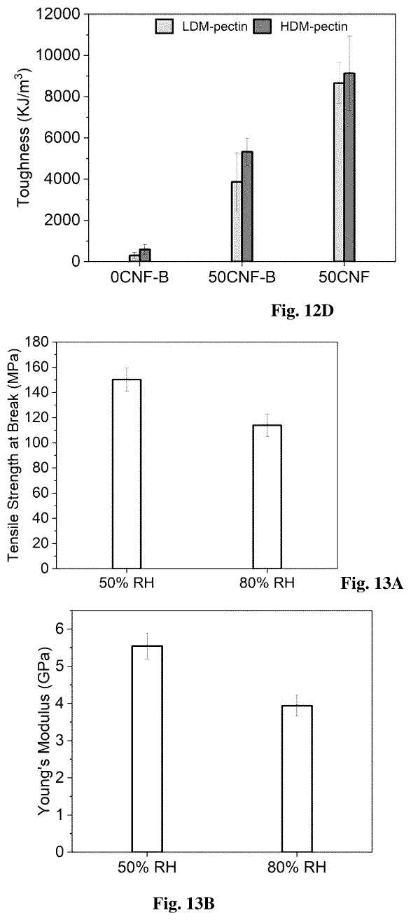

The effects of NaB loading and methoxyl content (LDM versus HDM pectin) on tensile properties at 80% RH are more nuanced (Tables 3-4). NaB loadings below 1.6 wt % or less provide the greatest TS and toughness, for example, TS of L-50CNF-B_{1.6} is 150 MPa comparable to that of 50 wt % bacterial nanocellulose (BNC) in pectin (132 MPa) but has greater ductility and toughness (EB=6.3% vs. 1.9%). Higher NaB loadings 14 wt % reduces TS and toughness of L-40CNF and L-50CNF but produces mixed effects on TS and EB for L-60CNF with overall retention of toughness (FIGS. 10A-10D). The degradation of tensile strength by high NaB loading can be attributed to the disruption of hydrogen bonding at high pH, and a reduction in pectin molecular weight due to base-induced scission (FIGS. 4 and 3D). In the absence of NaB, methoxyl content has a low impact on the mechanical properties of pectin-CNF composites, but a 14 wt % NaB loading in H-50CNF causes EB to decrease, resulting in an overall loss in toughness (FIGS. 12A-12D). On the other hand, the TS and E_{Y} of H-50CNF with 14 wt % NaB were greater than those of L-50CNF, likely related to the high density of carboxylate ions in the latter. Since the antioxidant properties of H-50CNF-B and the toughness of L-50CNF-B films are both retained at NaB loading of 1.6 wt % (FIGS. 3C and 10D), we consider these formulations to be most appropriate for prospective packaging applications. The tensile properties of select specimens were also evaluated at 50% RH, which produced diverse effects (Table 5). Samples of H-50CNF with 14 wt % NaB exhibit higher TS and E_{Y} at 50% RH but lower ductility, resulting in an overall reduction in toughness relative to that at 80% RH (FIGS. 13A-13D). Conversely, the tensile strength of L-50CNF-B is adversely affected at lower RH, and stress-strain measurements are highly variable. The low ductility of pectin-CNF at 50% RH indicates the importance of incorporating plasticizers to avoid changes in physical properties in dry environments.

TABLE 5
Uniaxial tensile measurements of HDM pectin-CNF films at 50 and 80% RH.

| Relative | | | | | |
|---|---|---|---|---|---|
| Humidity | Sample ID^{a} | Thickness (mm) | TS (MPa) | E (GPa) | EB (%) |
| 50% | H-50CNF-B | 0.244 ± 0.031 | 150.2 ± 9.5 | 5.55 ± 0.36 | 3.95 ± 0.53 |
| 80% | H-50CNF-B | 0.256 ± 0.036 | 114.0 ± 9.0 | 3.94 ± 0.28 | 6.68 ± 0.40 |

^{a}B = 14 wt % NaB.

Pure pectin films at 80% RH are mechanically weaker than most of known materials (TS: 2-6 MPa; E_{Y}: 0.02-0.1 GPa), but pectin blended with 50-60 wt % CNF increases tensile strength and toughness by nearly two orders of magnitude (up to 150 MPa and 8.5 MJ/m³ respectively, FIGS. 10A-10D).

In summary, pectin reinforced with cellulose nanofibers forms composites with mechanical strength and toughness many times greater than that of pectin alone. Blending pectin-CNF composites with a mild base such as NaB or NaC increases their antioxidant capacity through the generation of unsaturated pectic acid units and protects air-sensitive foods from oxidative deterioration, comparable to conventional thermoplastic barriers. Pectin-CNF-NaB composite barriers are also buffers against large RH changes and are excellent candidates for MAP applications that require humidity regulation during refrigeration or in ambient conditions, as demonstrated by improved moisture retention with strawberries and sliced apple halves. Lastly, pectin-CNF composites are clearly biodegradable and well aligned with missions to design sustainable single-use packaging for the preservation of perishable foods. Pectin-CNF-NaB composite barriers are mechanically robust at 80% RH with tensile strength and toughness as high as 150 MPa and 8.5 MJ/m²· respectively.

While specific embodiments of the subject invention have been disclosed herein, the above specification is illustrative and not restrictive. While this invention has been particularly shown and described with references to preferred embodiments thereof, it will be understood by those skilled in the art that various changes in form and details may be made therein without departing from the scope of the invention encompassed by the appended claims. Many variations of the invention will become apparent to those of skilled art upon review of this specification. Unless otherwise indicated, all numbers expressing reaction conditions, quantities of ingredients, and so forth, as used in this specification and the claims, are to be understood as being modified in all instances by the term “about.” Accordingly, unless indicated to the contrary, the numerical parameters set forth herein are approximations that can vary depending upon the desired properties sought to be obtained by the present disclosure.

As used herein, the following terms and phrases shall have the meanings set forth below. Unless defined otherwise, all technical and scientific terms used herein have the same meaning as commonly understood to one of ordinary skill in the art.

The term “about” can allow for a degree of variability in a value or range, for example, within 10%, within 5%, or within 1% of a stated value or of a stated limit of a range.

The term “substantially” can allow for a degree of variability in a value or range, for example, within 90%, within 95%, or within 99% of a stated value or of a stated limit of a range.

The terms “a,” “an,” or “the” are used to include one or more than one unless the context clearly dictates otherwise. The term “or” is used to refer to a nonexclusive “or” unless otherwise indicated. In addition, the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. The terms “including” and “having” are defined as comprising (i.e., open language).

Those skilled in the art will recognize that numerous modifications can be made to the specific implementations described above. The implementations should not be limited to the particular limitations described. Other implementations may be possible.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

All patents, patent application publications, journal articles, textbooks, and other publications mentioned in the specification are indicative of the level of skill of those in the art to which the disclosure pertains. All such publications are incorporated herein by reference to the same extent as if each individual publication were specifically and individually indicated to be incorporated by reference. In the event of inconsistent usages between this document and those documents so incorporated by reference, the usage in the incorporated reference should be considered supplementary to that of this document; for irreconcilable inconsistencies, the usage in this document controls.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

What is claimed is:

1. A pectin-based composite barrier comprising (i) a pectin, (ii) a cellulose nanofiber (CNF), and (iii) a mild base selected from sodium borate (NaB) and sodium carbonate (NaC).

2. The pectin-based composite barrier of claim 1, wherein the pectin-based composite barrier comprises about 17 wt % to about 70 wt % of CNF.

3. The pectin-based composite barrier of claim 2, wherein the pectin-based composite barrier comprises about 30 wt % to about 70 wt % of CNF.

4. The pectin-based composite barrier of claim 1, wherein the pectin-based composite barrier comprises about 25 wt % to about 80 wt % of pectin.

5. The pectin-based composite barrier of claim 1, wherein an amount of pectin and an amount of CNF used are in a weight ratio of about 80:20 to about 30:70.

6. The pectin-based composite barrier of claim 1, wherein the pectin-based composite barrier comprises about 0.1 wt % to about 15 wt % of the mild base.

5. The pectin-based composite barrier of claim 1, wherein the pectin-based composite barrier comprises about 43% of pectin, about 43% of CNF, and about 14% of NaB.

6. The pectin-based composite barrier of claim 1, wherein the pectin-based composite barrier is a composite film or a composite coating.

7. The pectin-based composite barrier of claim 6, wherein the pectin-based composite film has a thickness from about 0.10 mm to about 1.0 mm.

8. The pectin-based composite barrier of claim 6, wherein the pectin-based composite film has a tensile strength between about 5.5 MPa and about 160 MPa.

9. The pectin-based composite barrier of claim 8, wherein the tensile strength is measured at about 70-80% of relative humidity (RH).

10. A packaging product comprising a pectin-based composite barrier of claim 1.

11. The packaging product of claim 10, which is a modified atmosphere packaging product.

12. The packaging product of claim 10, wherein the pectin-based composite barrier can maintain a relative humidity (RH) from about 55% to about 70% and a water absorption of about 5 mg/cm².

13. The packaging product of claim 12, wherein the RH can be maintained at a temperature of about 1° C. to about 3° C.

14. The packaging product of claim 10, wherein the pectin-based composite barrier comprises about 17 wt % to about 70 wt % of CNF.

15. The packaging product of claim 10, wherein the pectin-based composite barrier comprises about 30 wt % to about 70 wt % of CNF.

16. The packaging product of claim 10, wherein the pectin-based composite barrier comprises about 25 wt % to about 80 wt % of pectin.

17. The packaging product of claim 10, wherein an amount of pectin and an amount of CNF used are in a weight ratio of about 80:20 to about 30:70.

18. The packaging product of claim 10, wherein the pectin-based composite barrier comprises about 0.1 wt % to about 15 wt % of the mild base.

19. The packaging product of claim 10, wherein the pectin-based composite barrier is a composite film or a composite coating.

20. The packaging product of claim 10, wherein the pectin-based composite film has a tensile strength between about 5.5 MPa and about 160 MPa.
